(19) United States
(12) Patent Application Publication
(10) Pub. No.: US 2015/0103501 A1
(43) Pub. Date: Apr. 16, 2015

(54) ELECTRONIC APPARATUS

(71) Applicant: Kabushiki Kaisha Toshiba, Tokyo (JP)

(72) Inventors: Yuichi Hirai, Hamura-shi (JP); Katsuo Ozawa, Hamura-shi (JP)

(73) Assignee: Kabushiki Kaisha Toshiba, Tokyo (JP)

(21) Appl. No.: 14/244,751

(22) Filed: Apr. 3, 2014

Related U.S. Application Data
(60) Provisional application No. 61/891,832, filed on Oct. 16, 2013.

(51) Int. Cl. G06F 1/16

(52) U.S. Cl. CPC G06F 1/1633
USPC 361/752

(57) ABSTRACT

According to one embodiment, an electronic apparatus includes a housing, a circuit board arranged in the housing, a screw-receiving member having a threaded hole and mounted on the circuit board, a mounted component mounted on the circuit board and screw-attached to the screw-receiving member, and a support rib provided on an inner surface of the housing, configured to contact with the circuit board near the threaded hole and to support the circuit board.

### CROSS-REFERENCE TO RELATED APPLICATIONS

This application claims the benefit of U.S. Provisional Application No. 61/891,832, filed Oct. 16, 2013, the entire contents of which are incorporated herein by reference.

### FIELD

Embodiments described herein relate generally to an electronic apparatus.

### BACKGROUND

An electronic apparatus, e.g., a portable computer (notebook PC), tablet computer, etc., comprises a case that forms an outer wall and various electronic components, including a printed circuit board, in the case. Normally, a circuit board is secured by screws to a plurality of bosses that protrude from the inner surface of the case. A large number of electronic components and various connectors are mounted on the circuit board. The mounted electronic components also include ones that are attached to the circuit board by screws.

Electronic apparatuses have recently become smaller and thinner, and in some cases, screw-attached parts of a printed circuit board may suffer the following problems. If external stress is locally applied to the electronic apparatus, it is concentrated on screw-attached boss portions between the case and printed circuit board, very possibly damaging the circuit board. If the electronic components are screw-attached to the printed circuit board, moreover, stress may act on the screw-attached parts of the circuit board, possibly damaging the circuit board. If ribs and rib receivers are provided on the inner surface of the case and the printed circuit board, respectively, the rib receivers can accept neither component mounting nor pattern formation, so that the packaging density of the printed circuit board cannot be easily increased.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view showing an external appearance of a notebook PC according to an embodiment;

FIG. 2 is a perspective view showing the interior of a housing of the notebook PC;

FIG. 3 is an exploded perspective view of the notebook PC showing a printed circuit board and the inner surface of the housing;

FIG. 4 is a perspective view showing the lower surface side of the printed circuit board;

FIG. 5 is a perspective view showing support ribs formed on the inner surface of the housing;

FIG. 6A is a sectional view of the printed circuit board and housing taken along line A-A of FIG. 2;

FIG. 6B is a sectional view of the printed circuit board and housing taken along line B-B of FIG. 2.

FIG. 7 is a perspective view showing the interior of the housing of the notebook PC;

FIG. 8 is an exploded perspective view of the notebook PC showing the housing, a sub-printed circuit board, and mounted components;

FIG. 9 is an exploded perspective view of the housing showing the mounted components; and

FIG. 10 is a sectional view of the housing and sub-printed circuit board taken along line C-C of FIG. 7.

### DETAILED DESCRIPTION

Various embodiments will be described hereinafter with reference to the accompanying drawings. In general, according to one embodiment, an electronic apparatus comprises a housing; a circuit board arranged in the housing; a screw-receiving member comprising a threaded hole and mounted on the circuit board; a mounted component mounted on the circuit board and screwed to the screw-receiving member; and a support rib provided on an inner surface of the housing and configured to contact the circuit board near the threaded hole and to support the circuit board.

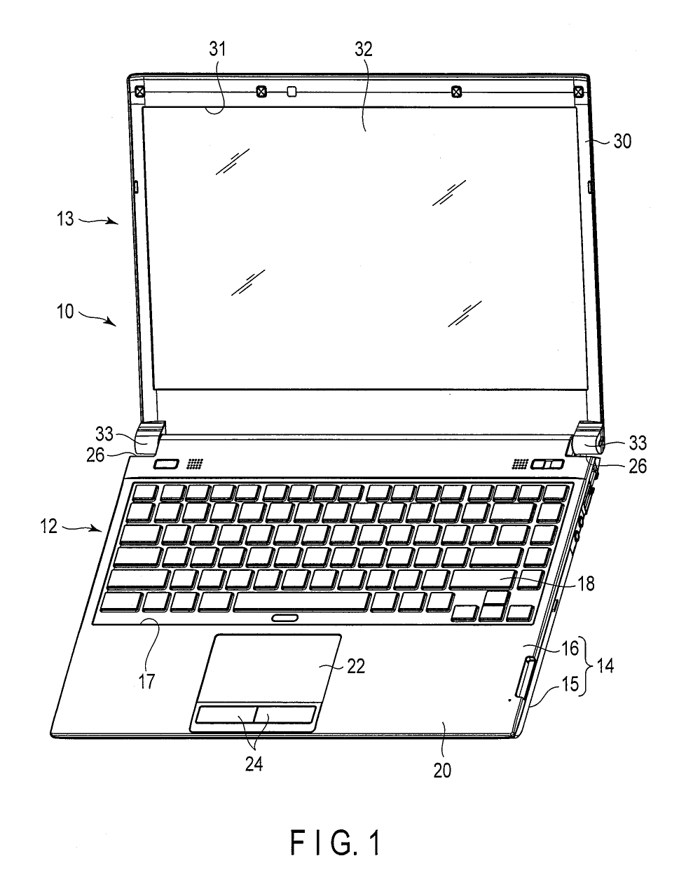

FIG. 1 shows a notebook personal computer (PC) as the electronic apparatus according to the embodiment.

As shown in FIG. 1, the personal computer 10 comprises an apparatus main body 12 and a display unit 13 supported thereon. The apparatus main body 12 comprises a housing 14. The housing 14 comprises a base 15, which has a rectangular bottom wall, and a top cover 16 having a substantially rectangular top wall and fitted on the base 15, thus constituting a flat box as a whole. For example, the housing 14 is made of a synthetic resin.

A substantially rectangular hollow 17 is formed covering the central and rear-half parts of the top cover 16, and a keyboard 18 is exposed in the hollow 17. A substantially front-half part of the top cover 16 forms a palmrest 20. A touchpad 22 and click switches 24 for operating a pointing device are provided in the central part of the palmrest 20. A pair of connecting hollows 26 are provided at the rear end portion of the top cover 16 so that they are spaced transversely relative to the housing 14.

The display unit 13 comprises a flat, rectangular display housing 30 and a liquid-crystal display panel 32 accommodated in the display housing 30. A display window 31 is formed in the front wall of the display housing 30. The window 31 is large enough to face the greater part of the front wall, and a display screen of the display panel 32 is exposed to the outside of the display housing 30 through the window 31.

The display housing 30 comprises a pair of legs 33 on its one end portion. These legs 33 are spaced transversely relative to the display housing 30 and engage individually with the connecting hollows 26 of the housing 14. The display housing 30 is pivotably supported on the housing 14 by hinges 27 (described later) provided at the connecting hollows 26 and the legs 33.

Thus, the display unit 13 is pivotable between closed and open positions. In the closed position, the display unit 13 is flattened so that it covers the upper surface of the housing 14 including the palmrest 20 and keyboard 18 from above. In the open position, the display unit 13 is raised so that the upper surface of the housing and the liquid-crystal display panel 32 are exposed. FIG. 1 shows the personal computer 10 with the display unit 13 in the opening position.

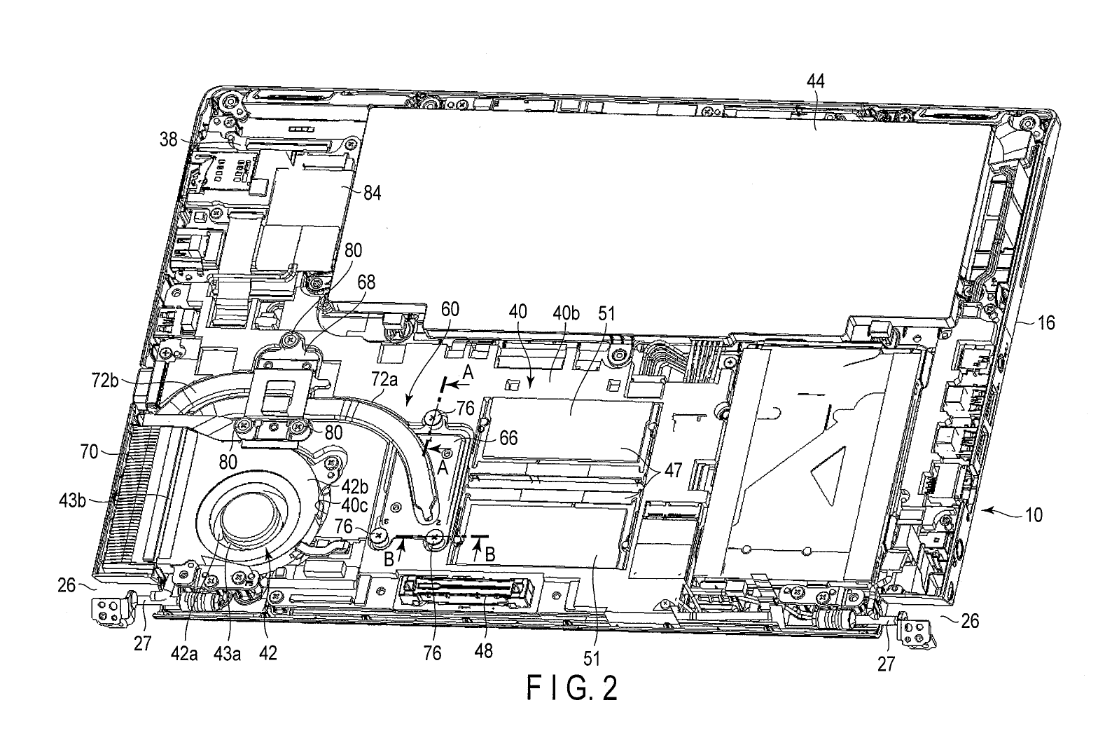

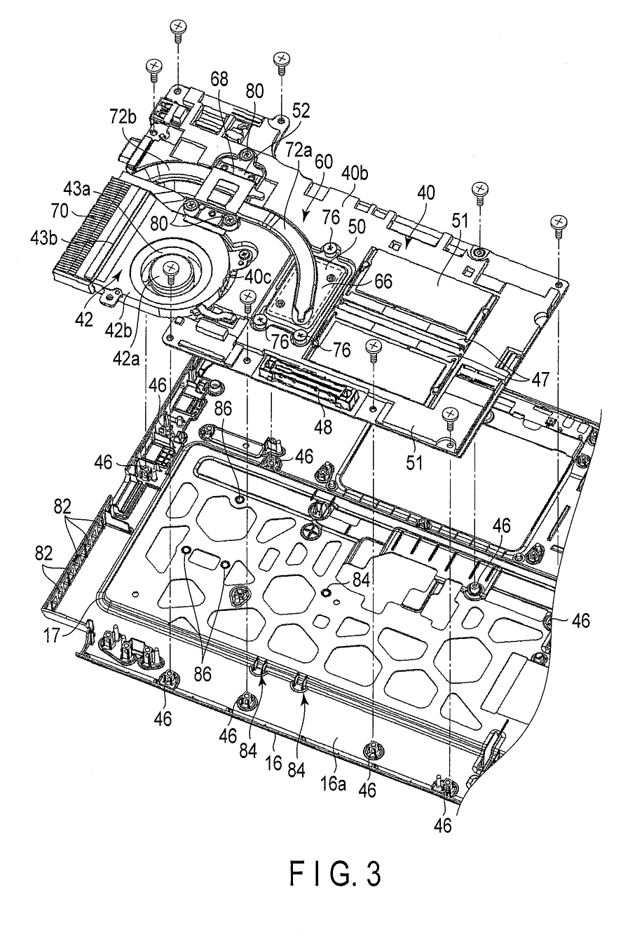

FIG. 2 is a perspective view showing the interior of the housing of the PC, and FIG. 3 is an exploded perspective view of the PC showing a main printed circuit board and the inner surface of the housing.

As shown in FIGS. 2 and 3, the housing 14 accommodates a main printed circuit board (motherboard) 40, sub-printed circuit board 38, cooling fan 42, various connectors, secondary battery 44, etc. The main printed circuit board 40 is secured by screws to a plurality of bosses 46, which are set up on an inner surface 16a of the top cover 16, and is opposed substantially parallel to the inner surface of the top cover 16 with a gap therebetween. In this arrangement, a plurality of spots in the peripheral edge portion of the main printed circuit board 40 are attached to the bosses 46 by screws. Further, the main printed circuit board 40 is formed in a substantially rectangular shape, and is arranged covering about half the area of the top cover 16 including a region below the keyboard 18.

The main printed circuit board 40 comprises a lower surface (first surface) 40a facing the inner surface 16a of the top cover 16 and an upper surface (second surface) 40b located on the opposite side to the lower surface. A large number of electronic components, connectors, etc., are mounted on the upper and lower surfaces 40b and 40a of the main printed circuit board 40.

For example, a connector 47 fitted with a memory board 51, CPUs 50 and 52 that produce relatively high heat, stacking connector 48, etc., are mounted on the central part of the upper surface 40b of the main printed circuit board 40. A cooling unit 60 for cooling these CPUs 50 and 52 is attached to the main printed circuit board 40.

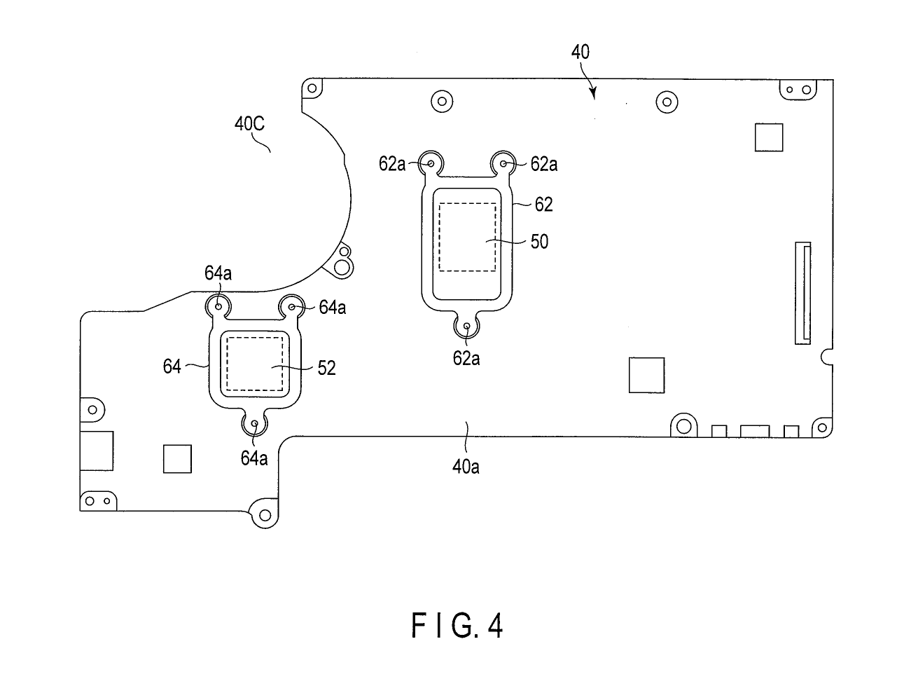

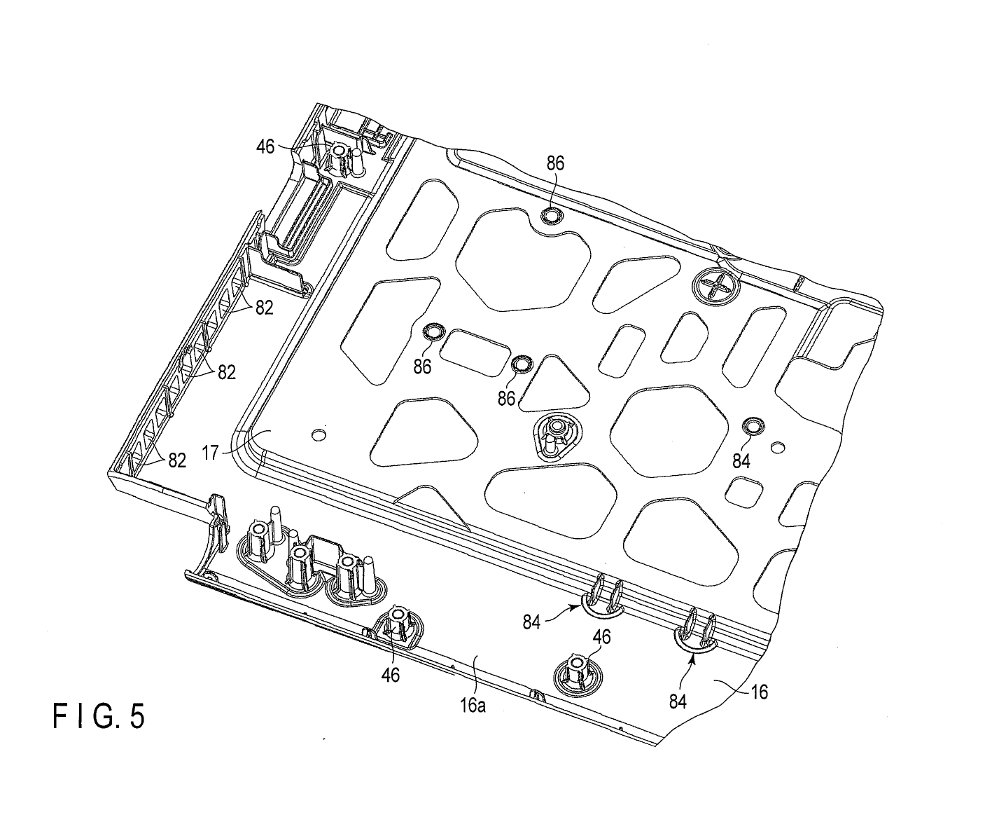

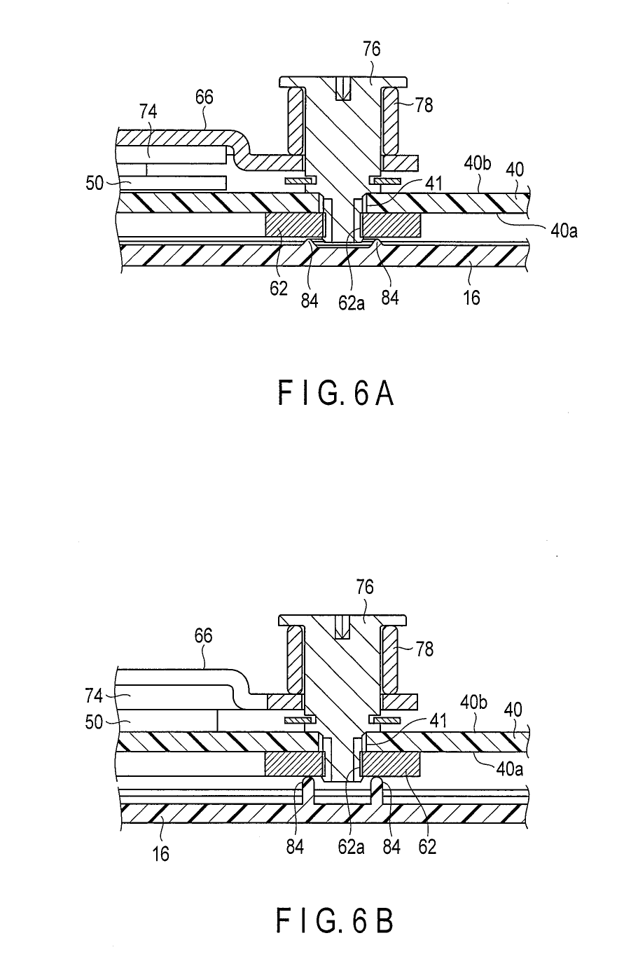

FIG. 4 is a perspective view showing the lower surface side of the printed circuit board, FIG. 5 is a perspective view showing support ribs formed on the inner surface of the housing, FIG. 6A is a sectional view of the printed circuit board and housing taken along line A-A of FIG. 2, and FIG. 6B is a sectional view of the printed circuit board and housing taken along line B-B of FIG. 2.

As shown in FIGS. 4, 6A and 6B, two mounting metal plates 62 and 64 for use as screw-receiving metal fittings are affixed to the lower surface 40a of the main printed circuit board 40. The mounting metal plate 62 is in the form of a rectangular frame and is affixed to the lower surface 40a of the main printed circuit board 40 in a position facing the periphery of the CPU 50. Further, the mounting metal plate 62 comprises a plurality of (e.g., three) threaded holes 62a, which are aligned individually with through-holes 41 for insertion formed in the main printed circuit board 40.

The mounting metal plate 64 is in the form of a rectangular frame and is affixed to the lower surface 40a of the main printed circuit board 40 in a position facing the periphery of the CPU 50. The mounting metal plate 64 comprises a plurality of (e.g., three) threaded holes 64a, which are aligned individually with through-holes for insertion formed in the main printed circuit board 40.

As shown in FIGS. 2, 3, 6A and 6B, the cooling unit 60 comprises the cooling fan 42, two heat sinks 66 and 68, a radiator fin block 70, and first and second heat pipes 72a and 72b. The heat sinks 66 and 68 are made of a high heat radiation metal, such as aluminum. The radiator fin block 70 is located opposite an exhaust port of the cooling fan 42. The heat pipes 72a and 72b serve to transmit heat from the heat sinks 66 and 68 to the radiator fin block 70.

The heat sink 66 that functions as a heat radiation part is formed to be sufficiently larger than the CPU 50 and is located overlapping the CPU 50. Further, the heat sink 66 is in contact with the CPU 50 with a heat transfer sheet 74 sandwiched therebetween. The heat sink 66 is located opposite the upper surface 40b of the main printed circuit board 40 and supported on the circuit board 40 by fixing screws 76 at a plurality of (e.g., three) positions around the CPU 50. Each fixing screw 76 is driven into its corresponding threaded hole 62a of the mounting metal plate 62 on the lower surface side through the heat sink 66 and the through-hole 41 of the main printed circuit board 40. Furthermore, the heat sink 66 is elastically pressed against the CPU 50 by coil springs 78 located individually around the fixing screws 76 so as to be interposed between the heat sink 66 and the respective heads of the fixing screws. Thus, the heat sink 66 can closely contact the CPU 50 to reliably remove heat from the CPU.

Likewise, the heat sink 68 is formed to be sufficiently larger than the CPU 52 and is located overlapping the CPU 52. Further, the heat sink 68 is in contact with the CPU 52 with a heat transfer sheet (not shown) sandwiched therebetween. The heat sink 68 is located opposite the upper surface 40b of the main printed circuit board 40 and supported on the circuit board 40 by fixing screws 80 at a plurality of (e.g., three) positions around the CPU 52. Each fixing screw 80 is driven into its corresponding threaded hole 64a of the mounting metal plate 64 on the lower surface side through the heat sink 68 and a through-hole (not shown) of the main printed circuit board 40. Furthermore, the heat sink 68 is elastically pressed against the CPU 52 by coil springs (not shown) located individually around the fixing screws 80 so as to be interposed between the heat sink 68 and the respective heads of the fixing screws. Thus, the heat sink 68 can closely contact the CPU 52 to reliably remove heat from the CPU.

The first heat pipe 72a has its one end portion secured on the heat sink 66 by welding or bonding and is located just above at least the CPU 50. The other end portion of the first heat pipe 72a is connected to the radiator fin block 70. Further, the middle portion of the first heat pipe 72a is brought into contact with or secured to the other heat sink 68.

The second heat pipe 72b has its one end portion secured on the heat sink 68 by welding or bonding and is located just above at least the CPU 52. The other end portion of the second heat pipe 72b is connected to the radiator fin block 70.

As shown in FIGS. 2 to 4, one corner of the main printed circuit board 40 is notched to form a substantially rectangular opening 40c. The cooling fan 42 is located in the opening 40c. The cooling fan 42 comprises a fan 42a and fan case 42b surrounding the fan. The fan case 42b is made of a synthetic resin or metal such as aluminum and is formed with an inlet port 43a and exhaust port 43b. The fan case 42b is attached to a boss on the inner surface of the top cover 16 and an end edge portion of the main printed circuit board by screws.

A plurality of exhaust slots 82 are formed in a sidewall of the top cover 16. The exhaust port 43b of the fan case 42b is located opposite the exhaust slots 82. The radiator fin block 70 comprising a large number of radiator fins extends to the outside of the main printed circuit board 40 and is located between the exhaust port 43b of the cooling fan 42 and the exhaust slots 82 of the top cover 16.

According to the cooling unit 60 constructed in this manner, heat from the CPUs 50 and 52 is transmitted to the first and second heat pipes 72a and 72b through the heat sinks 66 and 68, and moreover, to the radiator fin block 70 by the heat pipes 72a and 72b. Then, the radiator fin block 70 is cooled by cooling air from the cooling fan 42. In this way, the CPUs 50 and 52 are cooled by the cooling unit 60.

As shown in FIGS. 3, 5, 6A and 6B, a plurality of support ribs protrude from the inner surface of the top cover 16. Each support rib is molded integrally with the top cover 16. The support ribs are provided corresponding to the mounted components and screw-receiving metal fittings that are attached to the main printed circuit board 40 by screws. In the present embodiment, the support ribs include three first support ribs 84 opposed to the mounting metal plate 62 and three second support ribs 86 opposed to the mounting metal plate 64.

The three first support ribs 84 are positioned near the three threaded holes 62a of the mounting metal plate 62 and shaped so that they can contact the mounting metal plate 62. Two of the first support ribs 84 are a pair of plate-shaped ribs that extend parallel to each other and contact the mounting metal plate 62 on either side of the threaded holes 62a. The remaining one first support rib 84 is provided on the bottom surface of the hollow 17 of the top cover 16 and is in the shape of a ring, e.g., a circular ring. This first support rib 84 contacts the mounting metal plate 62 around one of the threaded holes 62a. These three first support ribs 84 are formed with such a height that they contact or face the mounting metal plate 62 with a small gap therebetween.

The three second support ribs 86 are positioned near the three threaded holes 64a of the mounting metal plate 64 and shaped so that they can contact the mounting metal plate 64. Each second support rib 86 is provided on the bottom surface of the hollow 17 of the top cover 16 and is in the shape of a ring, e.g., a circular ring. Each second support rib 86 contacts the mounting metal plate 62 around its corresponding threaded hole 64a. These three second support ribs 86 are formed with such a height that they contact or face the mounting metal plate 62 with a small gap therebetween.

Since the support ribs are thus provided corresponding to the mounted components and screw-receiving metal fittings that are attached to the main printed circuit board 40 by screws, the printed circuit board can be supported by the first and second support ribs 84 and 86 if the circuit board 40 is distorted by external force or when the mounted components are attached to the circuit board by screws. Since the support ribs are shaped and positioned so that they do not interfere with the tips of the fixing screws, moreover, the penetration depth of the fixing screws can be adjusted to ensure satisfactory fastening.

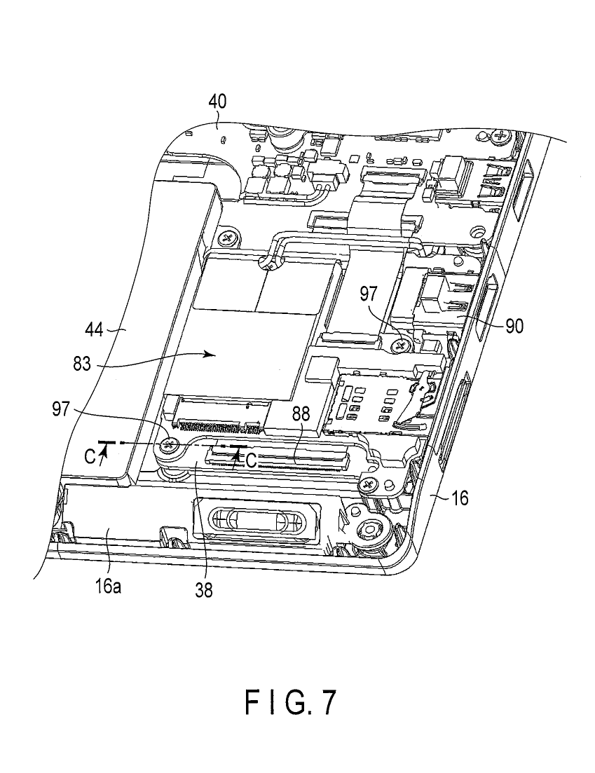

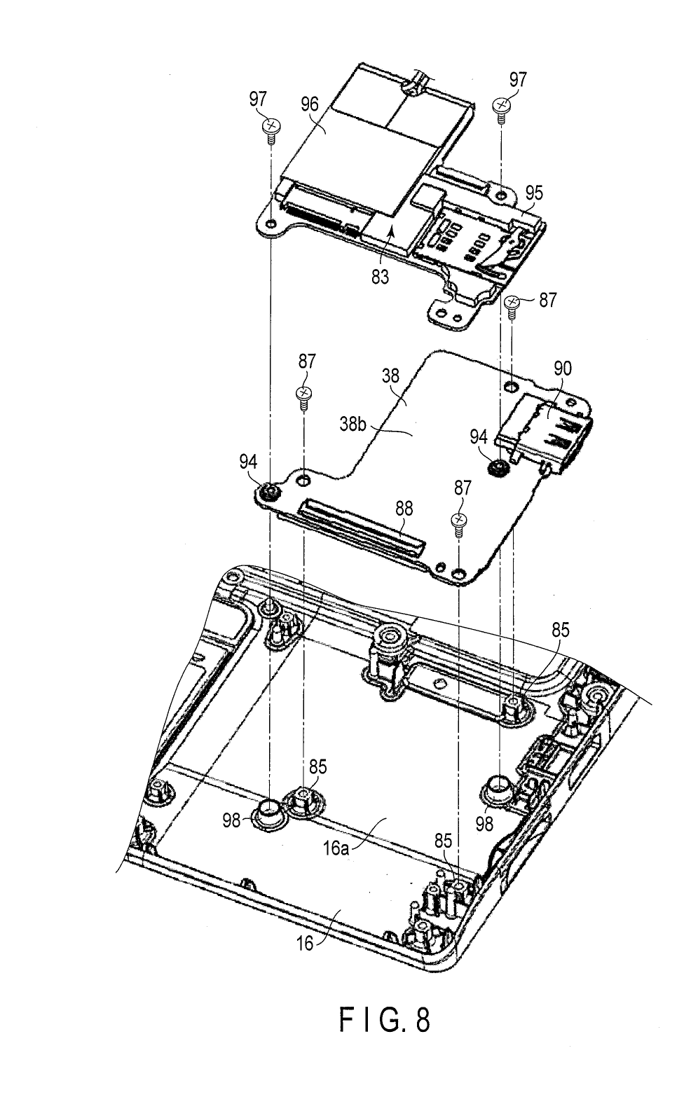

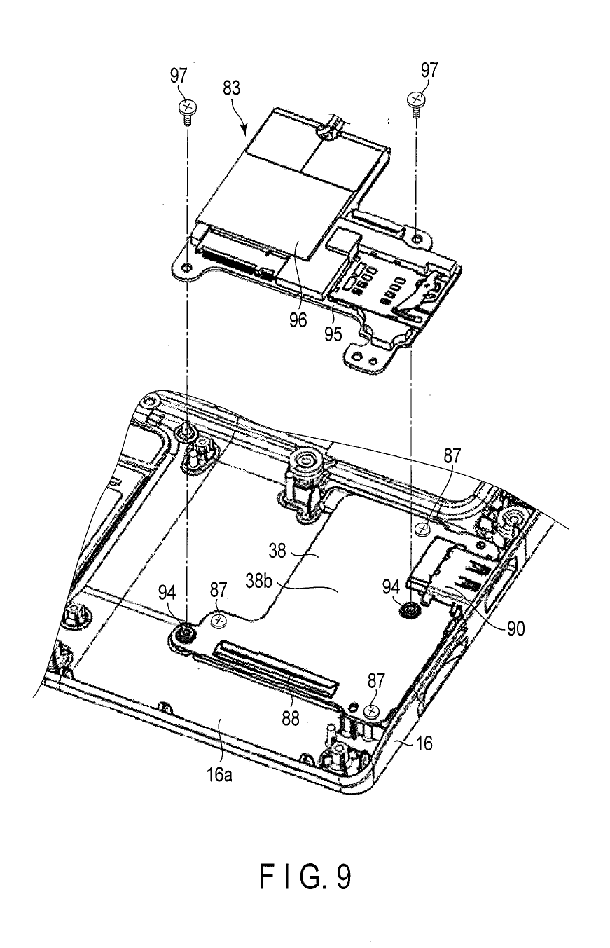

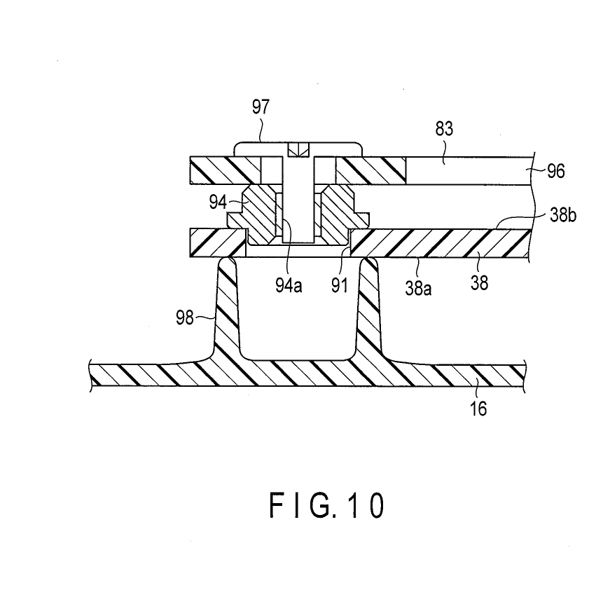

FIG. 7 is a perspective view showing the interior of the housing of the PC, FIG. 8 is an exploded perspective view of the PC showing the housing, sub-printed circuit board, and mounted components, FIG. 9 is an exploded perspective view of the housing showing the mounted components, and FIG. 10 is a sectional view of the housing and sub-printed circuit board taken along line C-C of FIG. 7.

As shown in FIGS. 2 and 7, the housing 14 accommodates the sub-printed circuit board 38 and mounted components, e.g., an antenna module 83, mounted on the circuit board 38. The sub-printed circuit board 38, along with the main printed circuit board 40 and secondary battery 44, is provided on the inner surface of the top cover 16.

As shown in FIGS. 7 to 10, the sub-printed circuit board 38 is secured by screws to a plurality of bosses 85, which are set up on the inner surface 16a of the top cover 16, and is opposed substantially parallel to the inner surface of the top cover 16 with a gap therebetween. In this arrangement, a plurality of spots in the peripheral edge portion of the sub-printed circuit board 38 are attached to the bosses 85 by screws.

The sub-printed circuit board 38 is formed in a substantially rectangular shape. The circuit board 38 comprises a lower surface (first surface) 38a facing the inner surface 16a of the top cover 16 and an upper surface (second surface) 38b located on the opposite side to the lower surface. A relay connector 88 and interface connector 90 are mounted on the upper surface 38b of the sub-printed circuit board 38. Through-holes 91 are formed individually in a plurality of portions, e.g., one corner portion and a center-side portion, of the sub-printed circuit board 38. Metal studs 94 are fitted individually into the through-holes 91 from the side of the upper surface 38b of the circuit board 38 and project upward from the upper surface 38b. A threaded hole 94a penetrates each metal stud 94 that serves as a screw-receiving metal fitting.

The antenna module 83 is mounted superposed on the upper surface 38b of the sub-printed circuit board 38. The antenna module 83 comprises, for example, a circuit board 95 with an area slightly smaller than that of the sub-printed circuit board 38 and an antenna board 96 mounted on the circuit board 95. The antenna module 83 is secured on the upper surface 38b of the sub-printed circuit board 38, that is, to the metal studs 94, by driving fixing screws 97 individually into the metal studs 94 through through-holes in the circuit board 95.

A plurality of (two in this case) support ribs 98 protrude from the inner surface of the top cover 16. Each support rib 98 is molded integrally with the top cover 16. The support ribs 98 are provided corresponding to mounted components and screw-receiving metal fittings that are attached to the sub-printed circuit board 38 by screws. In the present embodiment, the two support ribs 98 are located in positions facing the metal studs 94, individually.

Each support rib 98 is positioned near the threaded hole 94a of its corresponding metal stud 94 and shaped so that it can contact the lower surface 38a of the sub-printed circuit board 38. The support rib 98 is in the shape of a ring, e.g., a circular ring or cylinder, and contacts the sub-printed circuit board 38, surrounding the threaded hole 94a and facing the metal stud 94. The support rib 98 is formed with such a height that it contacts the lower surface 38a of the sub-printed circuit board 38 or faces the circuit board 38 with a small gap therebetween.

Since the support ribs 98 are thus provided corresponding to the mounted components and screw-receiving metal fittings that are attached to the sub-printed circuit board 38 by screws, screw-attached parts of the sub-printed circuit board can be supported by the support ribs 98 if the sub-printed circuit board is distorted by external force or when the antenna module (mounted component) 83 is attached to the sub-printed circuit board. Since the support ribs 98 are shaped and positioned so that they do not interfere with the tips of the fixing screws 97, moreover, the penetration depth of the fixing screws can be adjusted to ensure satisfactory fastening.

According to the personal computer 10 constructed in this manner, the printed circuit board can be supported by the support ribs on the inner surface of the housing, thereby avoiding distortion, when the keyboard 18 is depressed, if the PC is subjected to external force, or when the mounted components are screw-attached to the printed circuit board.

Since the support ribs on the housing side are received by the printed circuit board near the screw-receiving metal fittings (mounting metal plates) or the screw-attached parts at which the screw-receiving metal fittings are mounted, the printed circuit board can be prevented from being damaged by stress from outside the housing without newly providing rib receivers on the printed circuit board. In the case where the electronic components and the like are screw-attached to the printed circuit board installed on the inner surface of the housing, the peripheries of the screws are supported by the support ribs. Thus, an effect can be obtained to prevent the printed circuit board from being warped or damaged.

Since the support ribs are arranged so that they can contact the circuit board or screw-receiving metal fittings around and near the threaded holes, not just below the screws, moreover, there is no possibility of the screw tips contacting or interfering with the support ribs. Thus, the penetration depth of the screws can be adjusted to ensure satisfactory fastening.

According to the present embodiment, as described above, there can be provided an electronic apparatus in which the printed circuit board can be prevented from being damaged even when the housing is locally subjected to external force, the housing can be made thinner, and the reliability can be improved. In addition, the printed circuit board need not be furnished with independent rib receivers, so that its packing density can be increased.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, the support ribs should only be shaped so that they can contact the printed circuit board or screw-receiving means near the threaded holes. Each support rib is not limited to the shape of a circular ring, and may also be of various other shapes, such as prismatic, semicircular, or split shapes. The printed circuit board may be mounted on the inner surface of the base in place of the inner surface side of the top cover. In this case, the support ribs are provided on the inner surface of the base. The number of installed support ribs is not limited to the foregoing embodiment and may be increased or reduced as required. The screw-receiving means is not limited to metal fittings, such as metal plates, metal studs, etc., and may be made of another material such as a resin.

The electronic apparatus is not limited to the notebook personal computer and may be any of various other electronic apparatuses only if it comprises a housing and a printed circuit board disposed therein.

What is claimed is:

1. An electronic apparatus comprising:
a housing;
a circuit board arranged in the housing;
a screw-receiving member comprising a threaded hole and mounted on the circuit board;
a mounted component mounted on the circuit board and screwed to the screw-receiving member; and
a support rib provided on an inner surface of the housing and configured to contact the circuit board near the threaded hole and to support the circuit board.

2. The electronic apparatus of claim 1, wherein the circuit board comprises a first surface facing the inner surface of the housing and a second surface located on the opposite side to the first surface,
the screw-receiving member comprises a mounting metal plate mounted on the first surface and comprising a threaded hole,
the mounted component is mounted on the second surface of the circuit board and attached to the circuit hoard by a screw driven into the threaded hole of the mounting metal plate through the circuit board, and
the support rib is formed for contact with the mounting metal plate in a position near the threaded hole and off a tip of the screw.

3. The electronic apparatus of claim 2, wherein the support rib comprises a plurality of plate-shaped support ribs located on either side of the threaded hole.

4. The electronic apparatus of claim 2, wherein the support rib comprises an annular rib configured to contact with the mounting metal plate around the threaded hole.

5. The electronic apparatus of claim 1, wherein the circuit board comprises a first surface facing the inner surface of the housing, a second surface located on the opposite side to the first surface, and a through-hole configured to be penetrated by a screw,
the screw-receiving member comprises a stud fitted into the through-hole and projecting on the side of the second surface, comprising a threaded hole, and
the mounted component is mounted on the second surface of the circuit board and attached to the circuit board by a screw driven into the stud, and
the support rib is formed for contact with the circuit board in a position near the through-hole of the circuit board and off a tip of the screw driven in the stud.

6. The electronic apparatus of claim 5, wherein the support rib comprises a plurality of plate-shaped support ribs located on either side of the threaded hole.

7. The electronic apparatus of claim 5, wherein the support rib comprises an annular rib configured to contact with the circuit board around the threaded hole.

8. The electronic apparatus of claim 1, wherein the circuit board is screw-attached to a boss protruding from the inner surface of the housing and opposed to the inner surface of the housing with a gap therebetween.
